(19) United States
(12) Patent Application Publication
(10) Pub. No.: US 2006/0136078 A1
(43) Pub. Date: Jun. 22, 2006

(54) Method of information technology application for food process

(76) Inventor: Lung-Chuan Chen, Yuan-Ho City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/013,962

(22) Filed: Dec. 16, 2004

(51) Int. Cl. G05B 19/42

(52) U.S. Cl. 700/86; 700/90

(57) ABSTRACT

The present disclosure relates generally to home application of consumer electronic devices, and in particular, to software Application Programming Interface (API) of food process in consumer electronic devices.

### FIELD OF THE DISCLOSURE

The present disclosure relates generally to home application of consumer electronic devices, and in particular, to software Application Programming Interface (API) of food process in consumer electronic devices.

### BACKGROUND

The evolution of human residence environment never stops. For thousands of years, mankind all over the world used different innovative technologies to improve living conditions. One recent and most significant example is known as Digital Home, i.e. applying information technology (IT) to living environment, which currently becomes a new direction of development for global IT industry. Utilization of IT on human living will definitely keep growing and expanding.

In particular, during recent years, people started to try to apply IT on cooking tools/devices in kitchens, such refrigerators, stove, microwave ovens, . . . etc. These devices could connect to network, such as Internet, and some of them might possess interactive or intelligent functions. However, the sales results proved these modified machines could not be wildly accepted by consumers. Thus the main vendors around the world focus on IT applications in living room, instead of kitchens.

While using new IT to facilitate human living becomes one hot topic, for example, in the realms of audio/video entertainment, mobile gaming, 3D display, home security, . . . , food is still the most important essence of human lives, particularly compared with entertainment, since people can live without entertainment, but it is definitely a stupid idea not to eat or-to drink for a whole week. Among others, foods unquestionably represent the number one need for people.

Meanwhile, in terms of global market value, IT application for nourishments surely means billions, or even much higher, of profits for no matter vendors, manufacturers, distributors and other related business services, providing itself a very strong reason for people to develop.

As a result, a question therein must be answered first: “how to effectively apply IT for possible issues related with foods, so as to evolve from the existing electronic kitchen devices and grasp market profits?” Because from different points of view, such as necessity for human beings, market magnitude, . . . , food process represents an innovative, lucrative and huge business potentials to be opened.

Thus there exists a need for solving the above-mentioned problem.

### SUMMARY

A method of IT application for food process; in particular, a software Application Programming Interface (API) of food processes in consumer electronic devices is disclosed.

In one embodiment of the present method, by means of various computer programming languages, such as high level languages, for example, Java®, C/C++, . . . and so forth; or using low level assembly languages for all kinds of suitable hardware, processors, chip domains, . . . , the present method can be implemented as a single or multiple Application Programming Interfaces (API's), which can be loaded and called by software programs.

### BRIEF DESCRIPTION OF THE DRAWINGS

FIG. 1 shows the flowchart of the present method.

FIG. 2 illustrates an exemplary food process Application Programming Interface (API) architecture in one embodiment of the invention.

FIG. 3 illustrates an exemplary and simplified technical stack diagram for commonly used computing devices.

### DETAILED DESCRIPTION

Traditionally people tend to apply technology simply based on technology. That is, we impost technology, such as Information Technology (IT), onto devices in accordance with what we think of being state-of-the-art for that technology. However, most people usually ignore one critical factor which very likely decides the future of such application: the real purpose of the targeted devices.

Take IT application on kitchen utensils for example, as vendors/manufacturers are aware of the huge value it can bring, many devoted to develop various sort of “net-connected” refrigerators, “smart” microwave ovens, “intelligent” cuisine station in kitchens. These innovative products did attract people's eyesight on newspaper or magazines for a while, but then faded out, because the sale results turned out to be very discouraging. Ignoring purpose of being can be very risky, especially for avant-garde IT application, since it usually means losses of precious resources, including money, manpower and time.

The inventor of the present method proposes the following idea While focusing on IT application of food-related issues, people should observe the reason why consumers spend a lot of money purchasing kitchen utensils: for storing and preparing/serving foods. If IT developers/vendors/manufacturers or other parties hope to use IT on food-related applications, then people should concentrate on foods. However, foods (static things) themselves can not cause any new benefits, it is the processes (dynamic procedures) that human beings impose thereon create added value. Thus, the inventor of the present method first concludes that food process is in fact the real target issues.

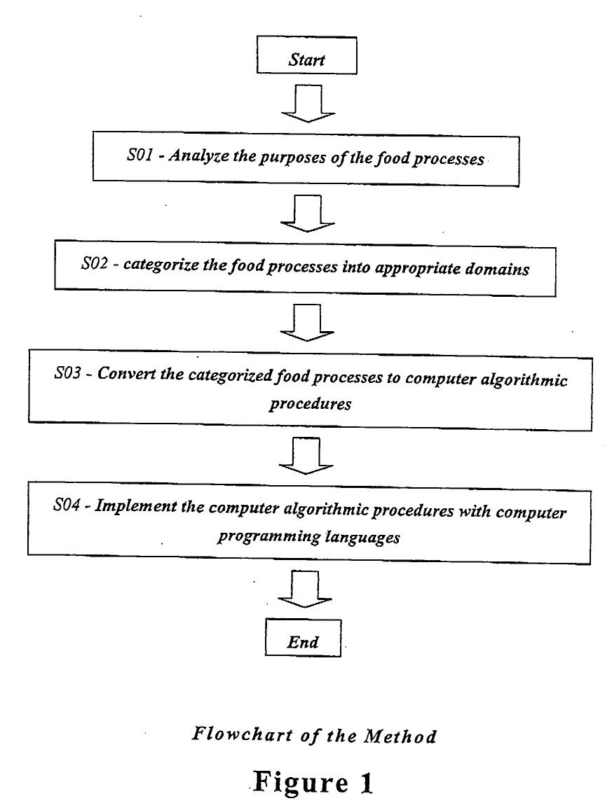

Based on the conclusion, the inventor of the present method proposes a way to examine food processes. FIG. 1 depicts a flowchart explaining the steps of the present method. In real lives, there exist numerous food processes, thus we may apply the present method in terms of one food process in the following steps: to analyze the purpose of the food process (S01); to categorize the food process into an appropriate domain (S02); to convert the categorized food process to computer algorithmic procedures (S03); and to implement the computer algorithmic procedures with computer programming languages (S04).

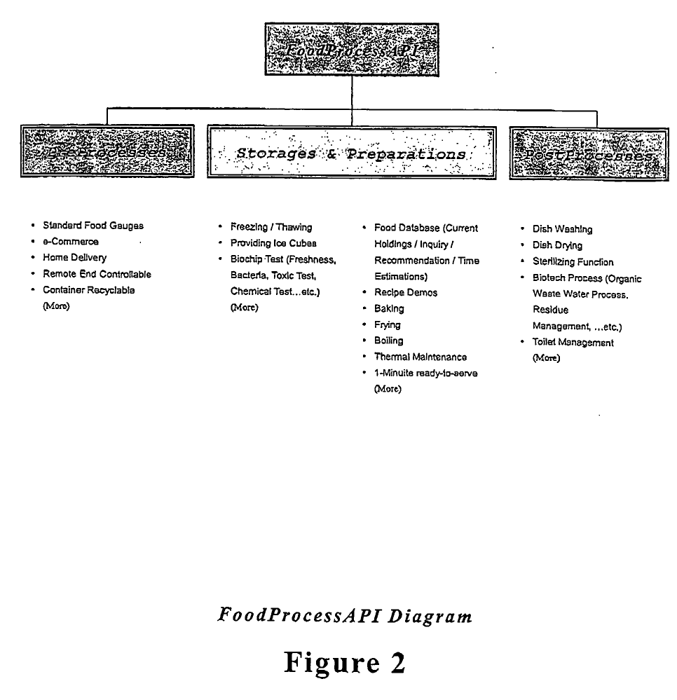

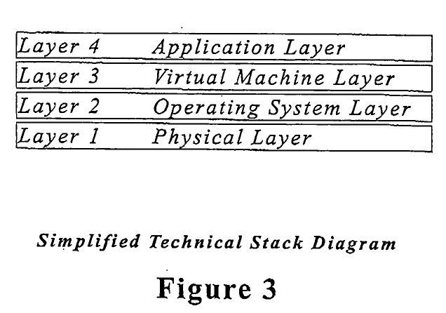

Then, while people examine numerous possible food processes, the inventor of the present method emphasizes these possible food processes collectively form a system. Now refer to FIG. 2, which depicts one possible analysis result and embodiment of the present method. This embodiment takes the form of Application Programming Interface (API) based on the software technology such as Java® software platform, which is available from Sun Microsystems, USA. The API is generally located at the third layer of computer technical stack, as briefly described in FIG. 3.

From above explanations, the inventor of the present method generally divides various food processes into 3 major categories, which are PreProcess, Storage&Preparation as well as PostProcess. Here the “PreProcess” category can be generally viewed as “all related actions concerning a state of food in which foods are ready to be stored in any way, from their original or natural forms”; for the “Storage&Preparation” category, it is about “all related actions concerning a state of food in which foods are stored and cooked or prepared or served in any way”. As for the “PostProcess” category, it broadly means “all related actions concerning a state of food in which foods have been digested in any way by living creatures or become residue, till reaching their final states of biological resolutions”.

In the PreProcess, it may involve food gauges standardization, e-Commerce online-trade, home delivery business, remote manipulation, recyclable containers specifications, . . . etc. In the Storage&Preparation part, it may include numerous items, such as freezing/thawing, ice cubes provisioning, mechanical/biological/chemical/physical tests (freshness, bacteria, toxic . . . ), as well as cooking database (current holdings/inquiry/recipe recommendations/time estimations/. . . ), recipe demos, baking, frying, boiling, thermal maintenance, 1-Minute fast food serving . . . and so forth. For the PostProcess, we may add functions such as dish washing, dish drying, sterilization, organic waste water process, residue management, toilet management for excreta . . . etc.

Developers may adopt any kind of programming philosophy to implement the above-mentioned API, for example, Object-Oriented Programming (OOP). One exemplary way to initiate the functions is, for example, to “import” the API (or the API's, if the above-mentioned system is implemented by several API's) into programs, use “constructors” to create instances and then call the interested methods. Taking another possible example, such as beef noodle of Chinese cooking, one possible coding result might resemble the following program codes:

...
import javax.FoodProcessAPI.Storage&Preparation.*;
import javax.FoodProcessAPI.PostProcess.*;
...
integer numberOfPersons; //for serving how many persons
ChineseFoodCook myChineseFoodCook = new
ChineseFoodCook( ); //instantiation
...
numberOfPersons =
myChineseFoodCook( ).getNumberOfPersons( );
//get the number
myChineseFoodCook( ).BeefNoodle(numberOfPersons);
//activate a static method
...
CleaningService myCleaningService =
new CleaningService( );//instantiation
myCleaningService.DishWashing( ); //clean up
...

We may take another example, such as eggs, to explain the above-mentioned details. While currently available eggs are all in original form, i.e. yoke+white+eggshell, companies of related industries can establish various standards for processing eggs, thus consumers purchase eggs at supermarkets or other sites in a form of yoke+white+a sealed and recyclable container of standard gauge (preprocess category). After having ordered the product in every possible ways, consumers can manually put the eggs in standard gauge into certain food processing machines at their kitchens and maintain them at low temperature (storage category). The food processing machines above-mentioned can be of any possible form, for example a stand-alone machine of such as 3 m(length)×1 m(width)×2 m(height) in size, which integrate currently applicable and/or future invented technologies of food storage and preparations. Thus this will not limit the scope of the present method.

During the maintenance period, the food processing machines may also check the status of foods, like contents, biological or chemical conditions . . . (storage category). When consumers would like to eat, at dinner for example, they can use various wired or wireless electronic devices to instruct the food processing machines and activate every possible functions to cook food (preparation category). They may for example instruct the machine to cook an egg soup or scrambled eggs. The machine then utilize stored food materials to achieve the instructed items, and provide consumers with the ordered food. After they finish the ordered foods, consumers can such as manually put used dishes, plates and other items in a dish-washing machine, which can be standalone or integrated into the above-mentioned food processing machines. Then the food processing machines wash and clean these used items (postprocess category).

All calls, invocations, activations, loading, . . . for instructing concerned physical devices and then executing proper functions can be accomplished locally, such as embedded in any possible forms into appropriate devices or loaded from any suitable physical or virtual media; or remotely, via wired/wireless network of any technology. Arguments/parameters for specifying any desired functions or requirements are also possible. Utilized physical devices can be any possible and suitable appliances, no matter presently or in the future, integrated into one single machine, or respectively stand-alone but connected devices via wired/wireless links.

It should be appreciated the implementations of the present method can be entirely or partially included in other API's. Furthermore, the embodiments, nomenclatures (such as API, PreProcess, Storage&Preparation, PostProcess, ChiueseFoodCook, applets, programs, . . . ), order/sequence/number of analysis steps, number of process categories (3, 4, 5, . . . ), food processes possibly currently involved or invented in the future, modeling fashions (e.g. object-oriented programming, procedural programming, . . . ) and other related details, logics, arrangements thereof shown and described herein are merely illustrative of the principles of the present method, and various modifications may naturally be realized by those skilled in the art without departing from the scope and spirit of the invention.

1. A method of IT application for food processes, comprising the steps of:
analyzing the purposes of the food processes;
categorizing the food processes into appropriate domains;
converting the categorized food processes to computer algorithmic procedures; and
implementing the computer algorithmic procedures with computer programming languages.

2. Method according to claim 1, in which categorizing the food processes into appropriate domains in one embodiment forms first, second and third domains.

3. Method according to claim 2, in which the first domain is about preprocesses of foods.

4. Method according to claim 3, in which the pre-processes of foods are about all related actions concerning a state of food in which foods are ready to be stored in any way, from their original or natural forms.

5. Method according to claim 2, in which the second domain is about storages and preparations of foods.

6. Method according to claim 5, in which the storages and preparations of foods are about all related actions concerning a state of food in which foods are stored and cooked or prepared or served in any way.

7. Method according to claim 2, in which the third domain concerns post-processes of foods.

8. Method according to claim 7, in which the post-processes of foods are about all related actions concerning a state of food in which foods have been digested in any way by living creatures or become residue, till reaching their final states of biological resolutions.

9. Method according to claim 1, in which converting the food processes to computer algorithmic procedures adopts Objected-Oriented programming (OOP) design.

10. Method according to claim 1, in which converting the food processes to computer algorithmic procedures adopts procedural programing design.

11. Method according to claim 1, in which the results of implementing the computer algorithmic procedures with computer programming languages creates a single Application Programming Interface.

12. Method according to claim 1, in which the results of implementing the computer algorithmic procedures with computer programming languages creates multiple Application Programming Interfaces.

13. Method according to claim 1, in which the results of implementing the computer algorithmic procedures with computer programming languages can be partially or entirely included in other software systems.

14. Method according to claim 13, in which the results of implementing the computer algorithmic procedures with computer programming languages that can be partially or entirely included in other software systems can be transmitted aria wired or wireless networks constructed with any present or future technologies.

15. Method according to claim 1, in which implementing the computer algorithmic procedures with computer programming languages utilizes high-level computer languages.

16. Method according to claim 15, in which implementing the computer algorithmic procedures with high-level computer programming languages utilizes C or C++ computer languages.

17. Method according to claim 15, in which implementing the computer algorithmic procedures with high-level computer programming languages utilizes Java computer language.

18. Method according to claim 15, in which implementing the computer algorithmic procedures with high-level computer programming languages utilizes Delphi computer language.

19. Method according to claim 15, in which implementing the computer algorithmic procedures with high-level computer programming languages utilizes C# computer language in NET software platform.

20. Method according to claim 1, in which implementing the computer algorithmic procedures with computer programming languages utilizes low-level computer languages.

21. Method according to claim 20, in which implementing the computer algorithmic procedures with low-level computer programming languages utilizes assembly computer languages for any specific hardware processors.
